(19) United States
(12) Patent Application Publication
(10) Pub. No.: US 2026/0332550 A1
(43) Pub. Date: Oct. 22, 2026

(54) INFORMATION PROCESSING APPARATUS, CONTROL METHOD FOR INFORMATION PROCESSING APPARATUS, AND STORAGE MEDIUM THAT ARE CAPABLE OF REDUCING MISSED REPLY TO MESSAGE

(71) Applicant: CANON KABUSHIKI KAISHA, Tokyo (JP)

(72) Inventor: KIICHI HASEGAWA, Kanagawa (JP)

(21) Appl. No.: 19/634,283

(22) Filed: Mar. 31, 2026

(30) Foreign Application Priority Data
Apr. 18, 2025 (JP) 2025-068635

(51) Int. Cl. H04L 51/23; H04L 51/216; H04L 51/224

(52) U.S. Cl. CPC H04L 51/23; H04L 51/216; H04L 51/224

(57) ABSTRACT

An information processing apparatus capable of reducing a missed reply to a message is provided. The information processing apparatus that is communicably connected to a plurality of terminal apparatuses and processes messages exchanged among the plurality of terminal apparatuses includes a unit that receives a message transmitted from one terminal apparatus included in the plurality of terminal apparatuses, in which a user has been identified, at least one processor, and a memory coupled to the processor storing instructions that, when executed by the processor, cause the processor to function as a notifying unit that, when the received message includes information indicating a request to notify the user and a reply message from another terminal apparatus other than the one terminal apparatus included in the plurality of terminal apparatuses has not yet been sent, notifies on the another terminal apparatus the user that the reply message has not yet been sent.

### BACKGROUND

### Field of the Technology

The present disclosure relates to an information processing apparatus, a control method for the information processing apparatus, and a storage medium.

### Description of the Related Art

For example, a business chat application such as LINE WORKS (registered trademark) or Microsoft Teams (registered trademark) allows users of the business chat application to transmit and receive messages. For example, Japanese Laid-Open Patent Publication (kokai) No. 2023-102486 describes a technique that, in order to improve the convenience of communication between users within an organization, generates feedback information that prompts, for example, a subordinate to reply to a message from his/her superior. With the technique described in Japanese Laid-Open Patent Publication (kokai) No. 2023-102486, a timing of transmitting the feedback information to the subordinate is capable of being set, for example, to after a business meeting has ended, based on emotional information about the superior's frustration with the subordinate for not replying.

However, the technique described in Japanese Laid-Open Patent Publication (kokai) No. 2023-102486 is not applied to a group chat in the business chat application. Therefore, for example, in the case where there are a relatively large number of users (members) participating in a group chat, messages are transmitted and received frequently, messages are transmitted and received quickly, and a plurality of topics are being discussed in parallel, there is a risk that replies will be forgotten, that is, missed replies will occur.

### SUMMARY

The present disclosure provides an information processing apparatus, a control method for the information processing apparatus, and a storage medium that are capable of reducing a missed reply to a message.

Accordingly, an aspect of the present disclosure provides an information processing apparatus that is communicably connected to a plurality of terminal apparatuses and processes messages exchanged among the plurality of terminal apparatuses, the information processing apparatus comprising a receiving unit configured to receive a message transmitted from one terminal apparatus included in the plurality of terminal apparatuses, in which a user has been identified, at least one processor, and a memory coupled to the processor storing instructions that, when executed by the processor, cause the processor to function as a notifying unit that, in a case where the message received by the receiving unit includes information indicating a request to notify the user and a reply message from another terminal apparatus other than the one terminal apparatus included in the plurality of terminal apparatuses has not yet been sent, notifies on the another terminal apparatus the user that the reply message has not yet been sent.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates an example of the overall configuration of a message application service according to a first embodiment.

FIG. 2 is a block diagram that illustrates an example of the hardware configuration of a message application server.

FIG. 3 is a block diagram that illustrates an example of the hardware configuration of a tenant server.

FIG. 4 is a block diagram that illustrates an example of the hardware configuration of a user terminal.

FIG. 5 is a diagram that illustrates an example of tenant information stored in an HDD of the tenant server.

FIG. 6 is a sequence diagram that illustrates processes executed between a first user terminal and the tenant server.

FIG. 7 is a diagram that illustrates an example of a personal setting screen displayed on an operation panel of the first user terminal.

FIG. 8 is a flowchart that illustrates a processing executed by the first user terminal.

FIG. 9 is a sequence diagram that illustrates processes executed among the first user terminal, a second user terminal, the message application server, and the tenant server.

FIG. 10A and FIG. 10B are diagrams that illustrate examples of a group chat screen displayed on the operation panel of each user terminal.

FIG. 11 is a flowchart that illustrates a processing executed by the message application server.

FIG. 12 is a sequence diagram that illustrates processes executed among the first user terminal, the second user terminal, a third user terminal, the message application server, and the tenant server according to a second embodiment.

FIG. 13 is a flowchart that illustrates a processing executed by the message application server in the second embodiment.

### DESCRIPTION OF THE EMBODIMENTS

The present disclosure will now be described in detail below with reference to the accompanying drawings showing embodiments thereof.

Hereinafter, each embodiment of the present disclosure will be described in detail with reference to the drawings. However, the configuration described in each embodiment below is merely an example, and the scope of the present disclosure is not limited by the configuration described in each embodiment. For example, each unit (each component) constituting the present disclosure can be replaced with a unit (a component) with any configuration that can perform the same function(s). In addition, any component(s) may be added. Furthermore, any two or more configurations (features) of each embodiment can be combined.

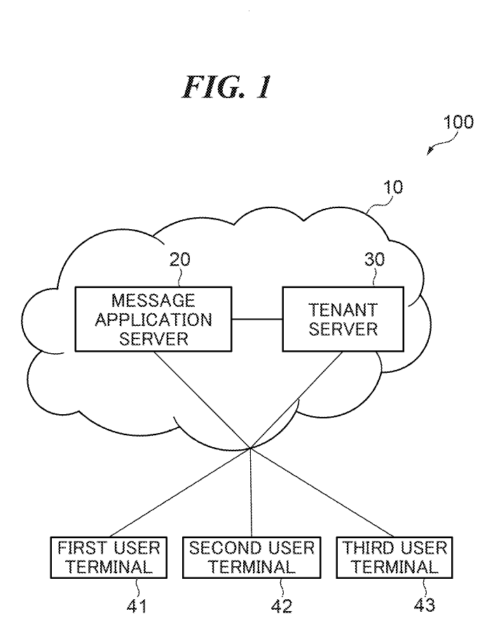

A first embodiment of the present disclosure will be described below with reference to FIGS. 1 -11. It should be noted that in the following description, “a tenant” refers to a group of elements such as users and applications. In addition, “a channel” is a subordinate concept of a group that is managed under the group. A channel corresponds to account information of users who belong to the channel. In addition, “a chat” is posted by a user, a bot, or the like, and is a message (a character string), data, or the like posted in a chat room for communication. In the present embodiment, it is not essential that there is a communication partner. In addition, generally, one chat is posted and displayed as one object.

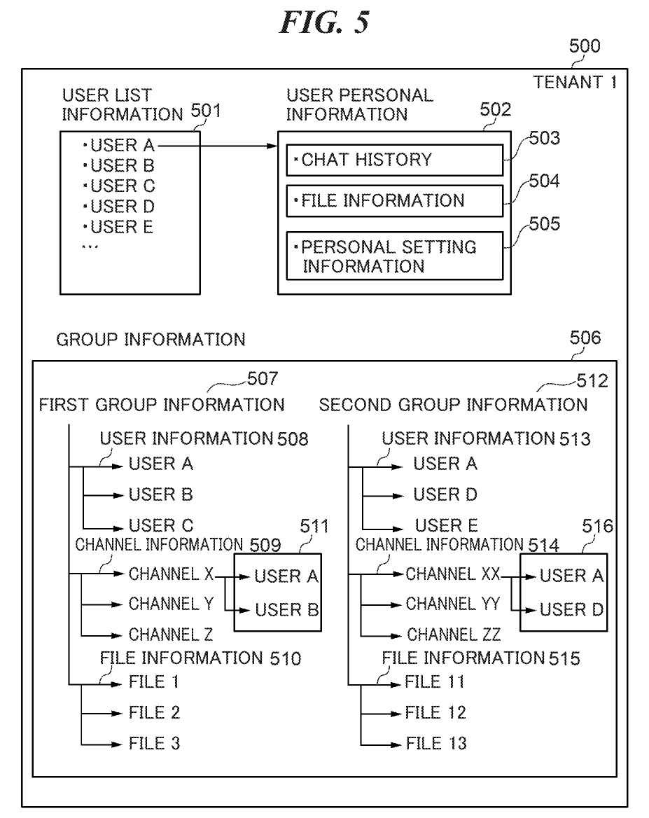

FIG. 1 is a block diagram that illustrates an example of the overall configuration of a message application service according to the first embodiment. A message application service 100 shown in FIG. 1 includes a message application server 20, a tenant server 30, a first user terminal 41, a second user terminal 42, and a third user terminal 43, which are connected to each other so as to be able to communicate with each other. The message application server 20 and the tenant server 30 are included in a cloud 10. It should be noted that although the number of user terminals is three in the configuration shown in FIG. 1, the number of user terminals is not limited to three, and may be, for example, two or four or more. The message application server 20 is a cloud server on the cloud 10. The message application server 20 processes messages exchanged among the first user terminal 41, the second user terminal 42, and the third user terminal 43. Examples of message processing include a message transmission and reception processing, a message display instruction processing, and the like. The tenant server 30 is a cloud server on the cloud 10. The tenant server 30 stores (saves) and provides tenant information 500 (see FIG. 5). The first user terminal 41, the second user terminal 42, and the third user terminal 43 are operated by respective users who use the message application service 100. The first user terminal 41, the second user terminal 42, and the third user terminal 43 are terminal apparatuses such as desktop or notebook type personal computers, tablet terminals, smartphones, etc.

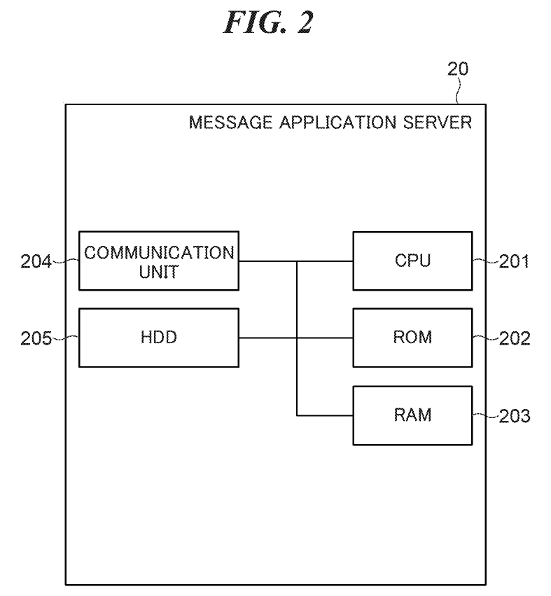

FIG. 2 is a block diagram that illustrates an example of the hardware configuration of the message application server. As shown in FIG. 2, the message application server 20 includes a CPU 201, a read only memory (a ROM) 202, a random access memory (a RAM) 203, a communication unit 204, and a hard disk drive (an HDD) 205. The CPU 201 is a computer that reads out a control program stored in the ROM 202 and various kinds of information stored in the HDD 205 into the RAM 203 and executes various kinds of processing for controlling the operation of the message application server 20. The ROM 202 stores the control program. This control program includes, for example, a program or the like that causes the CPU 201 to execute respective processes (respective steps) (a control method for an information processing apparatus) described below. The RAM 203 is used as a temporary storage area such as a main memory or a working area for the CPU 201. The communication unit 204 transmits and receives information to and from the tenant server 30, the first user terminal 41, the second user terminal 42, and the third user terminal 43. In this way, the communication unit 204 functions as a transmitting means (a transmitting unit) for transmitting information, and also functions as a receiving means (a receiving unit) for receiving information. The HDD 205 stores various types of data such as chat logs, images, and applications.

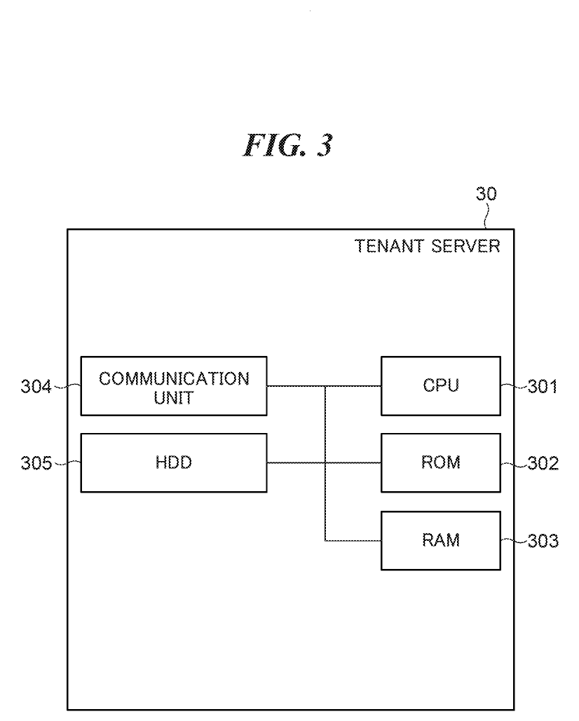

FIG. 3 is a block diagram that illustrates an example of the hardware configuration of the tenant server. As shown in FIG. 3, the tenant server 30 includes a CPU 301, a ROM 302, a RAM 303, a communication unit 304, and an HDD 305. The CPU 301 is a computer that reads out a control program stored in the ROM 302 and executes various kinds of processing for controlling the operation of the tenant server 30. The ROM 302 stores the control program. The RAM 303 is used as a temporary storage area such as a main memory or a working area for the CPU 301. The communication unit 304 transmits and receives information to and from the message application server 20, the first user terminal 41, the second user terminal 42, and the third user terminal 43. The HDD 305 stores the tenant information 500, etc. For example, there is a case where the tenant server 30 receives a request to obtain predetermined information within the tenant information 500 from the first user terminal 41 via the communication unit 304. In this case, the CPU 301 accesses the tenant information 500 by using the control program that has been loaded from the ROM 302 to the RAM 303.

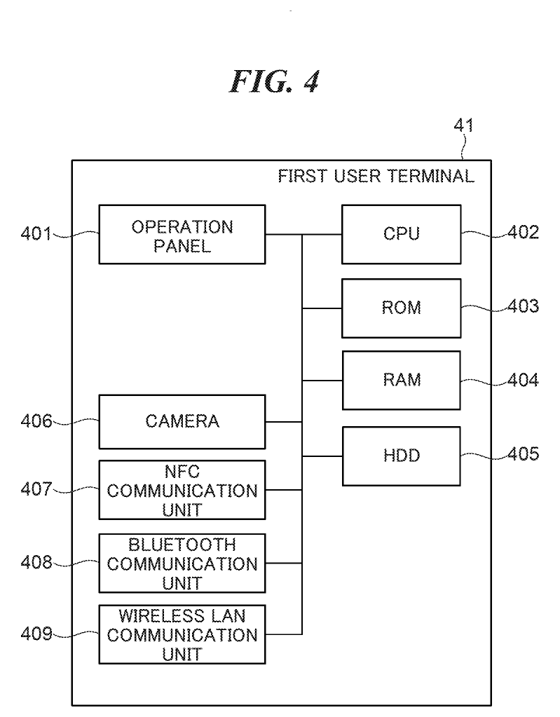

FIG. 4 is a block diagram that illustrates an example of the hardware configuration of the user terminal. In the present embodiment, since the first user terminal 41, the second user terminal 42, and the third user terminal 43 have the same hardware configuration, the hardware configuration of the first user terminal 41 will be described as a representative example. As shown in FIG. 4, the first user terminal 41 includes an operation panel 401, a CPU 402, a ROM 403, a RAM 404, an HDD 405, a camera 406, an NFC communication unit 407, a Bluetooth communication unit 408, and a wireless LAN communication unit 409. The CPU 402 is a computer that reads out a control program stored in the ROM 403 and various kinds of information stored in the HDD 405 into the RAM 404 and executes various kinds of processing for controlling the operation of the first user terminal 41. The ROM 403 stores the control program. The RAM 404 is used as a temporary storage area such as a main memory or a working area for the CPU 402. The HDD 405 stores various types of data such as images (photographs) and documents.

The operation panel 401 has a touch panel function that is capable of detecting touch operations performed by a user of the first user terminal 41. As a result, the user of the first user terminal 41 is able to input a desired operation instruction into the first user terminal 41. It should be noted that the operation panel 401 may also include a keyboard (not shown). In addition, the operation panel 401 is capable of displaying various kinds of screens provided by, for example, an operating system (OS), an email sending application, etc. In this way, in the present embodiment, the operation panel 401 also functions as a display means (a display unit) that displays a screen. The camera 406 captures image(s) in response to an image capture instruction issued by a user operation. The image(s) captured by the camera 406 is/are stored in a predetermined area of the HDD 405. In addition, the first user terminal 41 is capable of obtaining information from a QR code that has been read by the camera 406 by using a program capable of performing a QR code analysis. The NFC communication unit 407 performs communication via near field communication (NFC). The Bluetooth communication unit 408 performs communication via Bluetooth (registered trademark). The wireless LAN communication unit 409 performs communication via a wireless local area network (a wireless LAN). The first user terminal 41 is capable of communicating with the message application server 20 or the like via any one communication unit of the NFC communication unit 407, the Bluetooth communication unit 408, and the wireless LAN communication unit 409.

FIG. 5 is a diagram that illustrates an example of the tenant information stored in the HDD of the tenant server. The tenant information 500 shown in FIG. 5 includes user list information 501 and group information 506. The user list information 501 is a list of information about all users (a user A, a user B, . . .) included in the tenant information 500. In the user list information 501, user personal information 502 is linked to each user. Each piece of the user personal information 502 includes chat history information 503, file information 504, and personal setting information 505, but may also include other information. In FIG. 5, the user personal information 502 of the user A is representatively shown. The chat history information 503 is, for example, in the case of the user A, a chat history when the user A has chatted with other users, that is, the user B and the like. Since the chat log has been retained (stored) in the HDD 205 of the message application server 20, the chat history information 503 is stored at an address of a specific location on the HDD 205. The file information 504 is, for example, in the case of the user A, a file that the user A has uploaded to the tenant server 30. In addition, the file information 504 also includes a file that the user A has attached to the chat. The personal setting information 505 is, for example, in the case of the user A, business chat setting information set for the user A. It should be noted that in the case where the message application server 20 or the first user terminal 41 refers to specific user information in the user list information 501, an authentication function such as login authentication may be used. This authentication function is a publicly known function, and the description thereof will be omitted in the present embodiment.

The group information 506 is information about at least one group, and in the present embodiment, the group information 506 includes first group information 507 and second group information 512. The first group information 507 includes user information 508, channel information 509, and file information 510. The user information 508 is information about all users (the user A, the user B, and a user C) who belong to a first group. The user A, the user B, and the user C are each one of the users included in the user list information 501. The channel information 509 is information for grouping the users included in the user information 508, and includes a channel X, a channel Y, and a channel Z. For example, in the channel X, the user A and the user B are grouped together to constitute a user list 511. The file information 510 is information about files retained in the first group information 507, and includes a file 1, a file 2, and a file 3.

The second group information 512 includes user information 513, channel information 514, and file information 515. The user information 513 is information about all users (the user A, a user D, and a user E) who belong to a second group. The user A, the user D, and the user E are each one of the users included in the user list information 501. The channel information 514 is information for grouping the users included in the user information 513, and includes a channel XX, a channel YY, and a channel ZZ. For example, in the channel XX, the user A and the user D are grouped together to constitute a user list 516. The file information 515 is information about files retained in the second group information 512, and includes a file 11, a file 12, and a file 23.

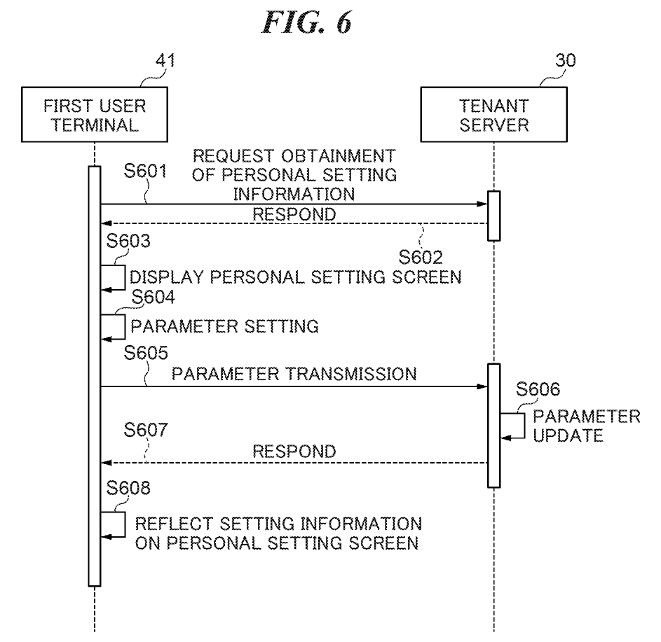

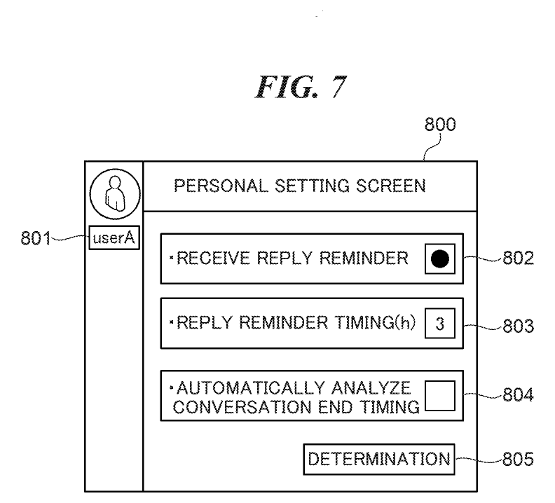

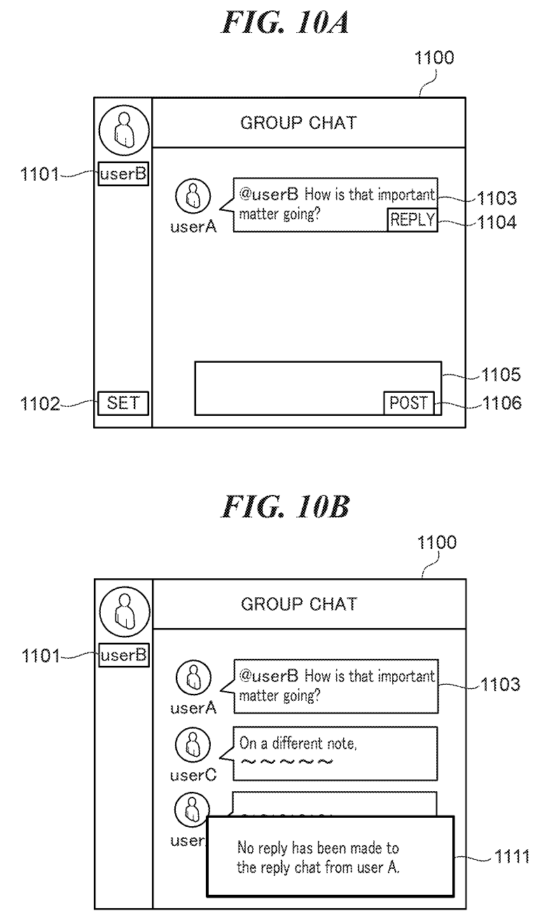

FIG. 6 is a sequence diagram that illustrates processes executed between the first user terminal and the tenant server. The sequence diagram shown in FIG. 6 shows a processing in which the first user terminal 41 notifies the tenant server 30 of the personal setting information 505. In addition, this processing is started by, for example, pressing a personal setting screen transition button 1102 on a group chat screen 1100 (see FIG. 10A). FIG. 7 is a diagram that illustrates an example of a personal setting screen displayed on the operation panel of the first user terminal. As shown in FIG. 6, in a step S601, the CPU 402 of the first user terminal 41 requests the tenant server 30 to obtain the personal setting information 505.

In a step S602, in the case where the CPU 301 of the tenant server 30 has received the request in the step S601 via the communication unit 304, the CPU 301 responds by sending the personal setting information 505 to the first user terminal 41.

In a step S603, the CPU 402 of the first user terminal 41 obtains the personal setting information 505 that has been sent in the step S602, and creates a personal setting screen 800 (see FIG. 7) with the personal setting information 505 as the initial value. The personal setting screen 800 is displayed on the operation panel 401 of the first user terminal 41. As shown in FIG. 7, the personal setting screen 800 includes a user information display region 801, a personal setting information parameter 802, a personal setting information parameter 803, a personal setting information parameter 804, and a personal setting information transmission button 805. The user information display region 801 displays the name or the like of the user for whom the personal setting information 505 is set. This user is one of the users included in the user list information 501.

With the personal setting information parameter 802, it is possible to set whether or not to receive a reply reminder, that is, to receive a notification that a reply message has not yet been sent (see a pop-up 1111 shown in FIG. 10B), which will be described below. In the case of receiving a reply reminder, a check box of the personal setting information parameter 802 is checked. With the personal setting information parameter 803, it is possible to set a reply reminder timing, that is, a timing when receiving the notification that a reply message has not yet been sent. In the case where a desired time (a predetermined time) is input into the personal setting information parameter 803 and a reply message has not yet been sent even after the input desired time (the input predetermined time) has elapsed, the notification that a reply message has not yet been sent is issued. With the personal setting information parameter 804, it is possible to set whether or not to automatically analyze a conversation end timing. In the case of automatically analyzing a conversation end timing, a check box of the personal setting information parameter 804 is checked. As a result, when a sender sends a message to a destination with an identified reader, if the message ends with a phrase such as “Thank you very much” or “I look forward to working with you”, it is determined that there is little need to send a reply message. It should be noted that in the initial state, the personal setting information parameter 802, the personal setting information parameter 803, and the personal setting information parameter 804 are all in an unset state, that is, are left blank. By pressing the personal setting information transmission button 805, it is possible to transmit information relating to the settings in the personal setting information parameter 802, the personal setting information parameter 803, and the personal setting information parameter 804 to the tenant server 30.

As shown in FIG. 6, in a step S604, the CPU 402 of the first user terminal 41 receives the information relating to the settings in the personal setting information parameter 802, the personal setting information parameter 803, and the personal setting information parameter 804.

In a step S605, in the case where the personal setting information transmission button 805 is pressed, the CPU 402 of the first user terminal 41 transmits, to the tenant server 30, the information relating to the settings in the personal setting information parameter 802, the personal setting information parameter 803, and the personal setting information parameter 804 that has been received in the step S604 (hereinafter, also referred to as “each piece of setting information”).

In a step S606, the CPU 301 of the tenant server 30 receives the each piece of setting information that has been transmitted in the step S605 and updates the personal setting information 505 with the each piece of setting information.

In a step S607, the CPU 301 of the tenant server 30 responds by sending, to the first user terminal 41, a message indicating that the update of the personal setting information 505 in the step S606 has been completed.

In a step S608, the CPU 402 of the first user terminal 41 updates the personal setting screen 800 with the each piece of setting information that has been received in the step S604, and displays, on the operation panel 401, the personal setting screen 800 that has been updated.

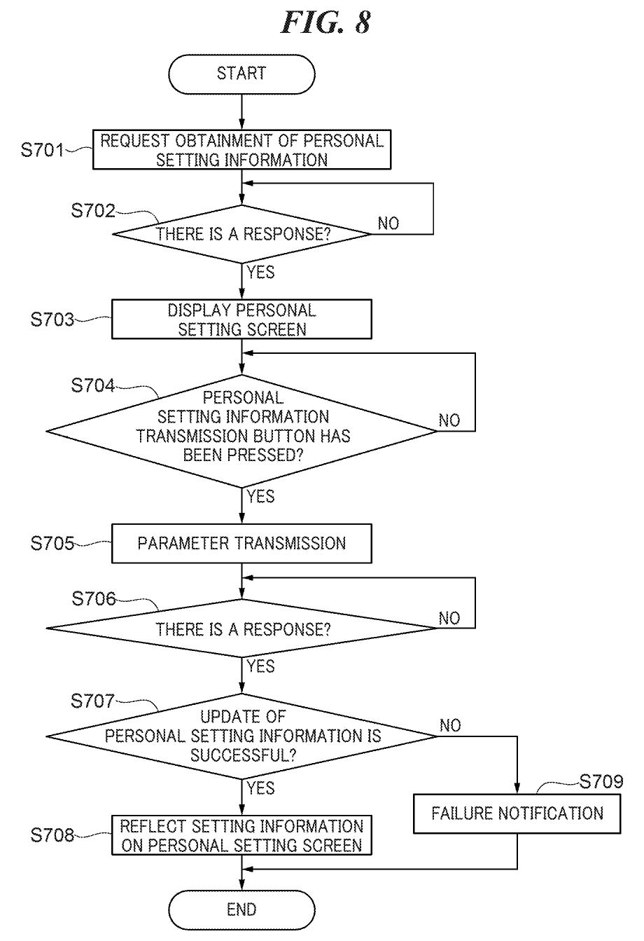

FIG. 8 is a flowchart that illustrates a processing executed by the first user terminal. As shown in FIG. 8, in a step S701, similar to the step S601, the CPU 402 of the first user terminal 41 requests the tenant server 30 to obtain the personal setting information 505.

In a step S702, the CPU 402 determines whether or not there is a response from the tenant server 30 in the step S602. As a result of the determination in the step S702, in the case of being determined that there is a response from the tenant server 30 in the step S602, the processing proceeds to a step S703. On the other hand, as the result of the determination in the step S702, in the case of being determined that there is no response from the tenant server 30 in the step S602, the processing remains in the step S702 and waits.

In the step S703, similar to the step S603, the CPU 402 obtains the personal setting information 505 included in the response from the tenant server 30, and creates the personal setting screen 800 with the personal setting information 505 as the initial value. The personal setting screen 800 is displayed on the operation panel 401 of the first user terminal 41.

In a step S704, similar to the step S604, the CPU 402 receives the settings in the personal setting information parameter 802, the personal setting information parameter 803, and the personal setting information parameter 804 on the personal setting screen 800. Then, the CPU 402 determines whether or not the personal setting information transmission button 805 has been pressed. As a result of this determination, in the case of being determined that the personal setting information transmission button 805 has been pressed, the processing proceeds to a step S705. On the other hand, as the result of this determination, in the case of being determined that the personal setting information transmission button 805 has not been pressed, the processing remains in the step S704 and waits.

In the step S705, similar to the step S605, the CPU 402 transmits, to the tenant server 30, the information relating to the settings in the personal setting information parameter 802, the personal setting information parameter 803, and the personal setting information parameter 804 that has been received in the step S704.

In a step S706, the CPU 402 determines whether or not there is a response from the tenant server 30 in the step S607. As a result of the determination in the step S706, in the case of being determined that there is a response from the tenant server 30 in the step S607, the processing proceeds to a step S707. On the other hand, as the result of the determination in the step S706, in the case of being determined that there is no response from the tenant server 30 in the step S607, the processing remains in the step S706 and waits.

In the step S707, the CPU 402 determines whether or not the update of the personal setting information 505 performed in the tenant server 30 has been successful, based on the response from the tenant server 30. As a result of the determination in the step S707, in the case of being determined that the update of the personal setting information 505 performed in the tenant server 30 has been successful, the processing proceeds to a step S708. On the other hand, as the result of the determination in the step S707, in the case of being determined that the update of the personal setting information 505 performed in the tenant server 30 has not been successful, that is, in the case of being determined that the update of the personal setting information 505 performed in the tenant server 30 has failed, the processing proceeds to a step S709.

In the step S708, similar to the step S608, the CPU 402 displays, on the operation panel 401, the personal setting screen 800 that has been updated, and then the processing ends.

In the step S709, the CPU 402 displays, on the operation panel 401, a message indicating that the update of the personal setting information 505 has not been successful (a failure notification), and then the processing ends.

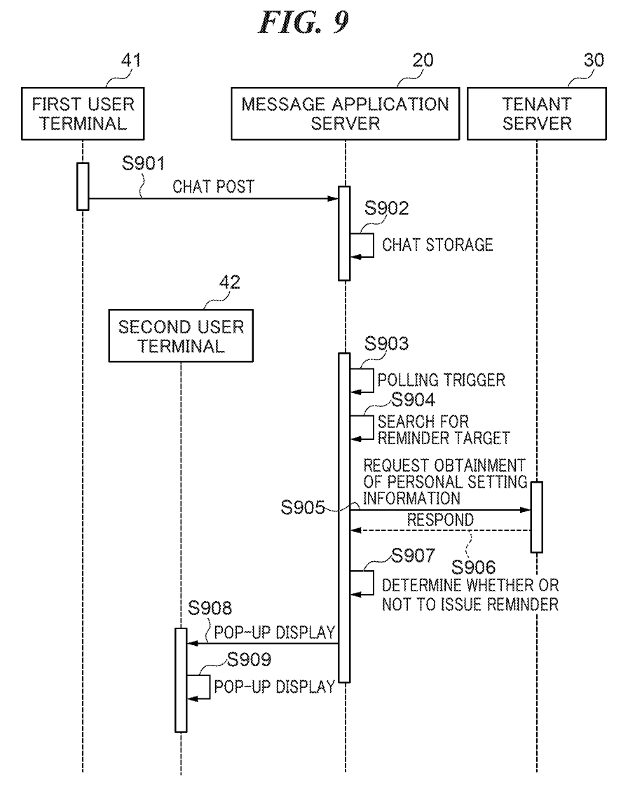

FIG. 9 is a sequence diagram that illustrates processes executed among the first user terminal, the second user terminal, the message application server, and the tenant server. The sequence diagram shown in FIG. 9 shows a processing of notifying a reply reminder. In addition, this processing is started by, for example, pressing a post button 1106 on the group chat screen 1100 (see FIG. 10A). Here, it is assumed that the first user terminal 41 is used by the user A, the second user terminal 42 is used by the user B, and the third user terminal 43 is used by the user C. FIGS. 10A and 10B are diagrams that illustrate examples of the group chat screen displayed on the operation panel of each user terminal. FIG. 10A is a diagram of the group chat screen in a first display state. FIG. 10B is a diagram of the group chat screen in a second display state transitioned from the first display state. The group chat screen 1100 is displayed in the case where an arbitrary group chat has been selected from, for example, a basic screen (not shown).

The group chat screen 1100 in the first display state, which is shown in FIG. 10A, includes a user information display region 1101, the personal setting screen transition button 1102, chat information 1103, a reply button 1104, a chat input field 1105, and the post button 1106. For example, in the case where the user B is operating the second user terminal 42, the user information display region 1101 displays the name or the like of the user B. The user B is one of the users included in the user list information 501. In addition, the user personal information 502 linked to the user list information 501 refers to the user personal information 502 of the user B. It should be noted that the user information display region 1101 may display the names or the like of all users in the group (the first group) to which the user B belongs. The personal setting screen transition button 1102 is a button for transitioning to the personal setting screen 800 (see FIG. 7). By pressing the personal setting screen transition button 1102, the personal setting screen 800 is displayed on the operation panel 401 of the second user terminal 42, and the processing shown in FIG. 6 is started.

The chat information 1103 displays chat information that is based on the chat history information 503. In the state shown in FIG. 10A, the chat information 1103 displays chat information sent by the user A, that is, a message “@user B, how is that important matter going?”. This message is a message sent from the first user terminal 41 (one user terminal) included in the first user terminal 41, the second user terminal 42, and the third user terminal 43. In addition, in this message, the user B who is the reader of the message has been identified. Furthermore, this message includes identification information that identifies the reader, i.e., the user B, and requests a reply message from the user B to the message. This identification information is “@user B” within the message. The reply button 1104 is a button for generating a reply message (a reply chat) to the user A who is the sender of the chat information 1103. Here, although the reply chat may be displayed in the chat input field 1105 as a chat from a reply source, but the present disclosure is not limited to this display.

The user B is able to input (enter), into the chat input field 1105, a message to be sent to the group chat of the first group by using text or the like. The post button 1106 is a button for sending, to the group chat of the first group, the message that has been input into the chat input field 1105. By pressing the post button 1106, the message that has been input into the chat input field 1105 is sent via the message application server 20 to all users in the first group to which the user B belongs.

The group chat screen 1100 in the second display state, which is shown in FIG. 10B, is in a state in which the group chat of the first group has been held a plurality of times since the first display state. The group chat screen 1100 shown in FIG. 10B includes the user information display region 1101, the chat information 1103, and the pop-up 1111. The pop-up 1111 is displayed (notified) in the case where the following two conditions are satisfied. The first condition is the case where the message from the user A includes information indicating a request to notify the user B of replying, that is, the case where the message from the user A includes the identification information. The second condition is the case where a reply message from the second user terminal 42 other than the first user terminal 41 (another user terminal) included in the first user terminal 41, the second user terminal 42, and the third user terminal 43 has not yet been sent, that is, the case where a reply message from the user B has not yet been sent. The pop-up 1111 displays that a reply message has not yet been sent. In the state shown in FIG. 10B, the pop-up 1111 displays a message “No reply has been made to the reply chat from user A”. The user B is able to visually recognize the pop-up 1111 displayed on the operation panel 401 of the second user terminal 42. As a result, it is possible to prevent a reply message to the chat information 1103 from having not been sent, that is, it is possible to reduce a missed reply to the message to the user A. It should be noted that the pop-up 1111 may have a hyperlink. In this case, by selecting the hyperlink, it is possible to access the chat information 1103 that requests a reply message. In addition, the pop-up 1111 may be displayed on a screen separate from the group chat screen 1100.

As shown in FIG. 9, in a step S901, the CPU 402 of the first user terminal 41 operated by the user A accepts an operation of the post button 1106 on the group chat screen 1100 displayed on the operation panel 401. At this time, a message has been input into the chat input field 1105. Then, by the operation of the post button 1106, the message within the chat input field 1105 is transmitted to the message application server 20, that is, a chat is posted. In addition, by message sending (chat posting) from the first user terminal 41, the group chat screen 1100 in the first display state, which is shown in FIG. 10A, is displayed on the operation panel 401 of the second user terminal 42 operated by the user B.

In a step S902, the CPU 201 of the message application server 20 controls the communication unit 204 to receive the message (the chat) from the first user terminal 41 that has been transmitted in the step S901. This message includes the identification information “@user B” that identifies the user B. In addition, this message is stored in the HDD 205. It should be noted that the message application server 20 may receive a plurality of messages, not just one message. In this case, in the message application server 20, each time a message is received, the received message is stored in the HDD 205.

In a step S903, the CPU 201 of the message application server 20 performs polling to perform a determination for displaying a reply reminder (the pop-up 1111) as a pop-up. Specifically, the CPU 201 determines, based on the identification information of the message that has been stored in the step S902, whether or not the message includes information indicating a reply request. This determination is repeatedly executed periodically until the exchange of messages between the first user terminal 41, the second user terminal 42, and the third user terminal 43 is completed.

In a step S904, the CPU 201 of the message application server 20 searches for chats that are reply reminder targets, by referring to the chat history information 503. “The reply reminder targets” refer to all messages that a reply is requested among all messages that have been received by the message application server 20. Here, it is assumed that one reply reminder target has been searched for.

In a step S905, the CPU 201 of the message application server 20 requests the tenant server 30 to obtain the personal setting information 505 of the user B.

In a step S906, in the case where the CPU 301 of the tenant server 30 has received the request in the step S905, the CPU 301 responds by sending the personal setting information 505 of the user B to the message application server 20.

In a step S907, the CPU 201 of the message application server 20 receives the personal setting information 505 of the user B that has been transmitted in the step S906. Then, the CPU 201 determines whether or not to issue a reply reminder, based on the personal setting information 505 of the user B. Specifically, the CPU 201 refers to the information in the personal setting information parameter 802 included in the personal setting information 505 of the user B to determine whether or not to issue a reminder. In addition, the CPU 201 refers to the information in the personal setting information parameter 803 to determine whether or not the reply reminder timing is met. Furthermore, the CPU 201 refers to the information in the personal setting information parameter 804 to determine whether or not the conversation has ended. Here, it is assumed that it is determined that a reply reminder is to be issued. In the present embodiment, the CPU 201 also functions as a determining means (a determining unit) that determines whether or not the message from the first user terminal 41 includes the information indicating a reply request and also determines whether or not a reply message to the message from the first user terminal 41 has not yet been sent.

In a step S908, the CPU 201 of the message application server 20 executes a display control to display a reply reminder in a pop-up (to pop up a reply reminder), that is, a notification control to notify the second user terminal 42 operated by the user B that a reply message has not yet been sent. It should be noted that in the case of being determined in the step S907 that a reply reminder will not be issued, the execution of the notification control is stopped. In addition, also in the case where the exchange of messages between the first user terminal 41, the second user terminal 42, and the third user terminal 43 has been completed, the execution of the notification control is stopped. In this way, in the present embodiment, the CPU 201 also functions as a notifying means (a notifying unit) that is capable of switching between the execution of the notification control and stopping the execution of the notification control.

In a step S909, the CPU 402 of the second user terminal 42 operated by the user B displays the group chat screen 1100 shown in FIG. 10B on the operation panel 401 in accordance with the notification control executed in the step S908. This group chat screen 1100 includes the pop-up 1111. As a result, the user B is able to visually recognize the pop-up 1111, thereby reducing a missed reply to the message to the user A.

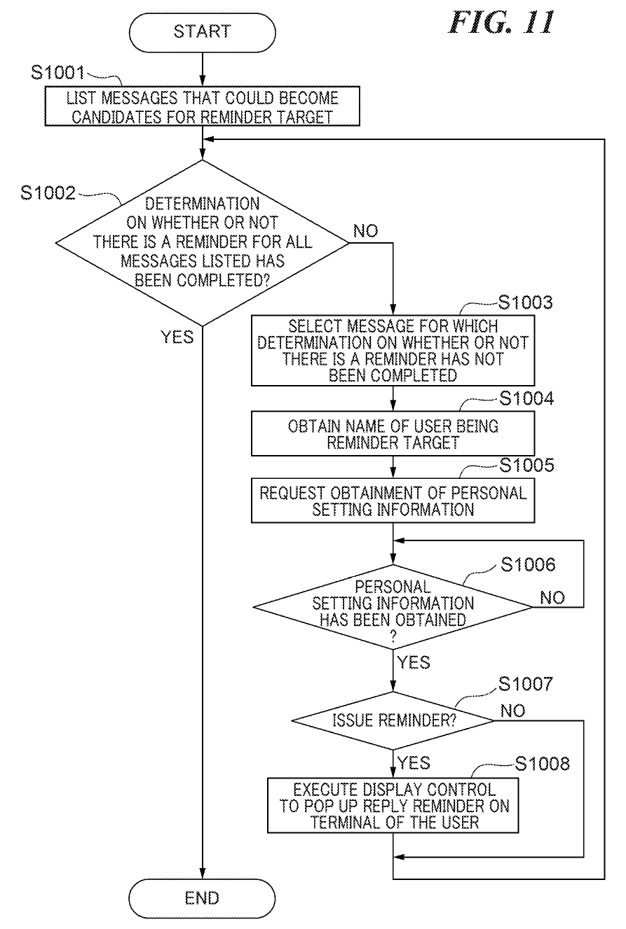

FIG. 11 is a flowchart that illustrates a processing executed by the message application server. As shown in FIG. 11, in a step S1001, the CPU 201 of the message application server 20 lists messages that could become candidates for the reply reminder target, among all messages that have been received by the message application server 20.

In a step S1002, similar to the step S904, the CPU 201 extracts one message from the messages listed in the step S1001 and determines whether or not the extracted message is the reply reminder target (whether or not there is a reply reminder for the extracted message). It should be noted that this determination is made for all the messages listed in the step S1001. Then, as a result of the determination in the step S1002, in the case of being determined that the determination as to whether or not there is a reply reminder for all the messages listed in the step S1001 has been completed, the processing ends. On the other hand, as the result of the determination in the step S1002, in the case of being determined that the determination as to whether or not there is a reply reminder for all the messages listed in the step S1001 has not been completed, the processing proceeds to a step S1003.

In the step S1003, the CPU 201 selects a message for which the determination as to whether or not there is a reply reminder has not been completed.

In a step S1004, the CPU 201 obtains the name of the user who becomes the reply reminder target with respect to the message that has been selected in the step S1003.

In a step S1005, similar to the step S905, the CPU 201 requests the tenant server 30 to obtain the personal setting information 505 of the user having the name that has been obtained in the step S1004.

In a step S1006, the CPU 201 determines whether or not the personal setting information 505, which has been transmitted from the tenant server 30 based on the request in the step S1005, has been obtained. As a result of the determination in the step S1006, in the case of being determined that the personal setting information 505 has been obtained, the processing proceeds to a step S1007. On the other hand, as the result of the determination in the step S1006, in the case of being determined that the personal setting information 505 has not been obtained, the processing remains in the step S1006 and waits.

In the step S1007, similar to the step S907, the CPU 201 determines whether or not to issue a reply reminder, based on the personal setting information 505 from the tenant server 30. As a result of the determination in the step S1007, in the case of being determined that a reply reminder is to be issued, the processing proceeds to a step S1008. On the other hand, as the result of the determination in the step S1007, in the case of being determined that a reply reminder is not to be issued, the processing returns to the step S1002, and the subsequent steps are executed in order.

In the step S1008, similar to the step S908, the CPU 201 executes the display control to display a reply reminder in a pop-up on the second user terminal 42 (to pop up a reply reminder on the second user terminal 42), that is, the notification control to notify the second user terminal 42 that a reply message has not yet been sent. As a result, the group chat screen 1100 including the pop-up 1111 is displayed on the operation panel 401 of the second user terminal 42. After the step S1008 is executed, the processing returns to the step S1002, and the subsequent steps are executed in order.

As described above, the above control allows the user B to visually recognize the pop-up 1111, thereby reducing a missed reply to the message to the user A. In addition, as described above, in the case where a desired time is input into the personal setting information parameter 803 of the personal setting screen 800 and a reply message has not yet been sent even after the input desired time has elapsed, the notification that a reply message has not yet been sent is issued (the notification control is executed). In this way, the message application server 20 is configured to be capable of changing the timing at which the notification control is executed. As a result, it is possible to adjust the frequency of the execution of the notification control. In addition, in the case where the number of times the same pop-up 1111 is displayed exceeds a threshold value, the message that is the display target of the pop-up 1111 may be excluded from the reply reminder. The threshold value in this case is capable of being changed as appropriate.

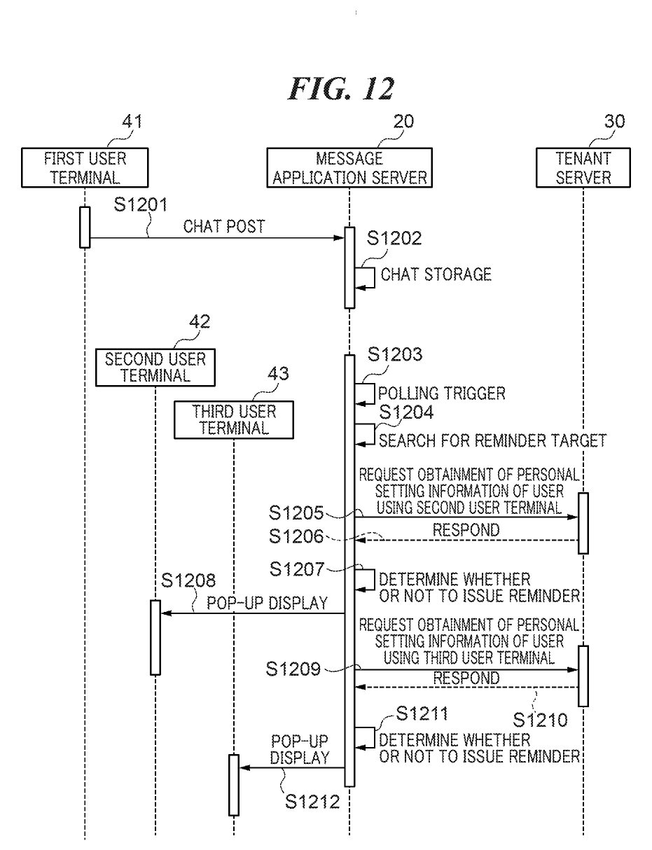

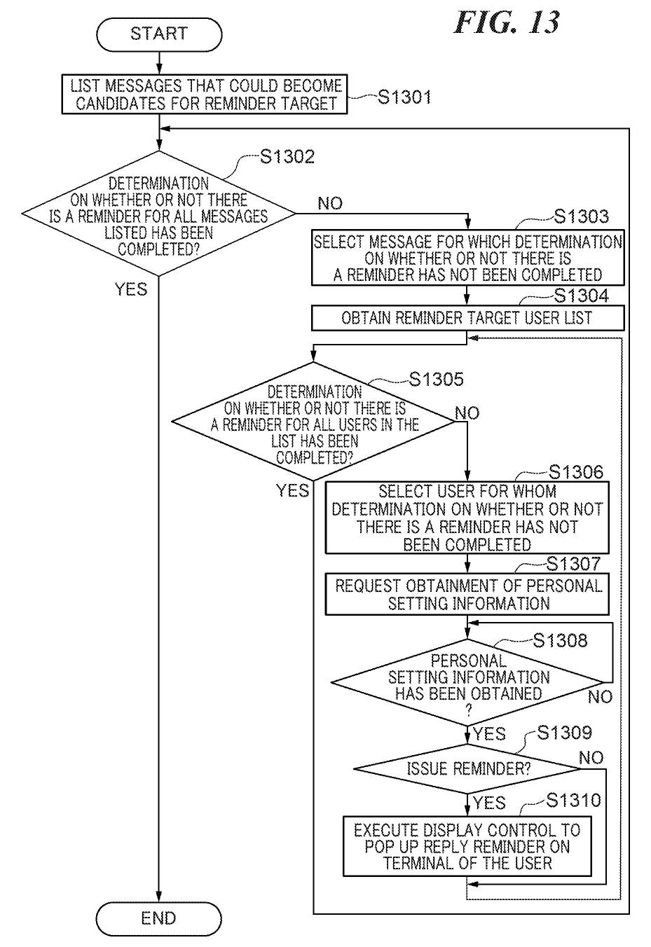

A second embodiment of the present disclosure will be described below with reference to FIGS. 12 and 13, with the differences from the above-described embodiment being mainly described, and descriptions of similar matters will be omitted. FIG. 12 is a sequence diagram that illustrates processes executed among the first user terminal, the second user terminal, the third user terminal, the message application server, and the tenant server according to the second embodiment. As shown in FIG. 12, in a step S1201, similar to the step S901, the CPU 402 of the first user terminal 41 operated by the user A accepts an operation of the post button 1106 on the group chat screen 1100 displayed on the operation panel 401. Then, by the operation of the post button 1106, the message within the chat input field 1105 is transmitted to the message application server 20.

In a step S1202, similar to the step S902, the CPU 201 of the message application server 20 controls the communication unit 204 to receive the message from the first user terminal 41 that has been transmitted in the step S1201. This message is stored in the HDD 205.

In a step S1203, similar to the step S903, the CPU 201 of the message application server 20 performs polling to perform a determination for displaying a reply reminder as a pop-up.

In a step S1204, similar to the step S904, the CPU 201 of the message application server 20 searches for chats that are reply reminder targets, by referring to the chat history information 503. Here, it is assumed that one reply reminder target has been searched for and a reply is requested with respect to the user B and the user C.

In a step S1205, similar to the step S905, the CPU 201 of the message application server 20 requests the tenant server 30 to obtain the personal setting information 505 of the user B.

In a step S1206, similar to the step S906, in the case where the CPU 301 of the tenant server 30 has received the request in the step S1205, the CPU 301 responds by sending the personal setting information 505 of the user B to the message application server 20.

In a step S1207, similar to the step S907, the CPU 201 of the message application server 20 receives the personal setting information 505 of the user B that has been transmitted in the step S1206, and determines whether or not to issue a reply reminder, based on the personal setting information 505 of the user B that has been received. Here, it is assumed that it is determined that a reply reminder is to be issued.

In a step S1208, similar to the step S908, the CPU 201 of the message application server 20 executes the display control (the notification control) to display a reply reminder in a pop-up on the second user terminal 42 (to pop up a reply reminder on the second user terminal 42). As a result, the group chat screen 1100 including the pop-up 1111 is displayed on the operation panel 401 of the second user terminal 42.

In a step S1209, the CPU 201 of the message application server 20 requests the tenant server 30 to obtain the personal setting information 505 of the user C.

In a step S1210, in the case where the CPU 301 of the tenant server 30 has received the request in the step S1209, the CPU 301 responds by sending the personal setting information 505 of the user C to the message application server 20.

In a step S1211, the CPU 201 of the message application server 20 receives the personal setting information 505 of the user C that has been transmitted in the step S1210, and determines whether or not to issue a reply reminder, based on the personal setting information 505 of the user C that has been received. Here, it is assumed that it is determined that a reply reminder is to be issued.

In a step S1212, the CPU 201 of the message application server 20 executes the display control (the notification control) to display a reply reminder in a pop-up on the third user terminal 43 (to pop up a reply reminder on the third user terminal 43). As a result, the group chat screen 1100 including the pop-up 1111 is displayed on the operation panel 401 of the third user terminal 43.

By the above control, the user B is capable of being notified on the second user terminal 42 that a reply message has not yet been sent, and the user C is capable of being notified on the third user terminal 43 that a reply message has not yet been sent.

FIG. 13 is a flowchart that illustrates a processing executed by the message application server in the second embodiment. As shown in FIG. 13, in a step S1301, the CPU 201 of the message application server 20 lists messages that could become candidates for the reply reminder target, among all messages that have been received by the message application server 20.

In a step S1302, similar to the step S1204, the CPU 201 determines whether or not there is a reply reminder for all the messages listed in the step S1301. As a result of the determination in the step S1302, in the case of being determined that the determination as to whether or not there is a reply reminder for all the messages listed in the step S1301 has been completed, the processing ends. On the other hand, as the result of the determination in the step S1302, in the case of being determined that the determination as to whether or not there is a reply reminder for all the messages listed in the step S1301 has not been completed, the processing proceeds to a step S1303.

In the step S1303, the CPU 201 selects a message for which the determination as to whether or not there is a reply reminder has not been completed.

In a step S1304, the CPU 201 obtains a list of users mentioned from the message that has been selected in the step S1303.

In a step S1305, the CPU 201 determines whether or not there is a reply reminder for all the users included in the list obtained in the step S1304. As a result of the determination in the step S1305, in the case of being determined that the determination as to whether or not there is a reply reminder for all the users included in the list obtained in the step S1304 has been completed, the processing returns to the step S1302, and the subsequent steps are executed in order. On the other hand, as the result of the determination in the step S1305, in the case of being determined that the determination as to whether or not there is a reply reminder for all the users included in the list obtained in the step S1304 has not been completed, the processing proceeds to a step S1306.

In the step S1306, the CPU 201 selects a user for whom the determination as to whether or not there is a reply reminder has not been completed.

In a step S1307, similar to the step S1205 and the step S1209, the CPU 201 requests the tenant server 30 to obtain the personal setting information 505 of the user that has been selected in the step S1306.

In a step S1308, the CPU 201 determines whether or not the personal setting information 505, which has been transmitted from the tenant server 30 based on the request in the step S1307, has been obtained. As a result of the determination in the step S1308, in the case of being determined that the personal setting information 505 has been obtained, the processing proceeds to a step S1309. On the other hand, as the result of the determination in the step S1308, in the case of being determined that the personal setting information 505 has not been obtained, the processing remains in the step S1308 and waits.

In the step S1309, similar to the step S1207 and the step S1211, the CPU 201 determines whether or not to issue a reply reminder, based on the personal setting information 505 from the tenant server 30. As a result of the determination in the step S1309, in the case of being determined that a reply reminder is to be issued, the processing proceeds to a step S1310. On the other hand, as the result of the determination in the step S1309, in the case of being determined that a reply reminder is not to be issued, the processing returns to the step S1305, and the subsequent steps are executed in order.

In the step S1310, similar to the step S1208 and the step S1212, the CPU 201 executes the display control (the notification control) to display a reply reminder in a pop-up (to pop up a reply reminder). As a result, the group chat screen 1100 including the pop-up 1111 is displayed on the operation panel 401 of the second user terminal 42 and the operation panel 401 of the third user terminal 43. After the step S1310 is executed, the processing returns to the step S1305, and the subsequent steps are executed in order.

In addition, although in the above-described embodiments, the present disclosure has been applied to the group chat, but is not limited thereto.

According to the present disclosure, it is possible to reduce a missed reply to the message.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068635, filed Apr. 18, 2025, which is hereby incorporated by reference herein in its entirety.

What is claimed is:

1. An information processing apparatus that is communicably connected to a plurality of terminal apparatuses and processes messages exchanged among the plurality of terminal apparatuses, the information processing apparatus comprising:
a receiving unit configured to receive a message transmitted from one terminal apparatus included in the plurality of terminal apparatuses, in which a user has been identified;
at least one processor; and
a memory coupled to the processor storing instructions that, when executed by the processor, cause the processor to function as:
a notifying unit that, in a case where the message received by the receiving unit includes information indicating a request to notify the user and a reply message from another terminal apparatus other than the one terminal apparatus included in the plurality of terminal apparatuses has not yet been sent, notifies on the another terminal apparatus the user that the reply message has not yet been sent.

2. The information processing apparatus according to claim 1, wherein
the notifying unit is configured to be capable of switching between execution of a notification control to notify the another terminal apparatus that the reply message has not yet been sent, and stopping the execution of the notification control.

3. The information processing apparatus according to claim 2, wherein
the notifying unit, in a case where the reply message has not yet been sent even after a predetermined time has elapsed, executes the notification control.

4. The information processing apparatus according to claim 2, wherein
the notifying unit is configured to be capable of changing a timing at which the notification control is executed.

5. The information processing apparatus according to claim 2, wherein
the notifying unit, in a case where the message exchange among the plurality of terminal apparatuses has been completed, stops the execution of the notification control.

6. The information processing apparatus according to claim 1, wherein
the processor is caused to further function as a determining unit that determines whether or not the message received by the receiving unit includes the information indicating a request to notify the user and also determines whether or not the reply message from the another terminal apparatus has not yet been sent.

7. The information processing apparatus according to claim 6, wherein
the message received by the receiving unit includes identification information that identifies the user, and
the determining unit determines whether or not the message received by the receiving unit includes the information indicating a request to notify the user, based on the identification information.

8. The information processing apparatus according to claim 6, wherein
the determination by the determining unit is repeatedly executed until the message exchange among the plurality of terminal apparatuses is completed.

9. The information processing apparatus according to claim 1, wherein
the plurality of terminal apparatuses each include a display unit for displaying a screen, and
the notifying unit causes the display unit of the another terminal apparatus to display on a screen that the reply message has not yet been sent.

10. The information processing apparatus according to claim 1, wherein
there are a plurality of users, and
the notifying unit notifies the plurality of users, by the another terminal apparatus used by each of the plurality of users, that the reply message has not yet been sent.

11. A control method for controlling an information processing apparatus that is communicably connected to a plurality of terminal apparatuses and processes messages exchanged among the plurality of terminal apparatuses,
the control method comprising:
a receiving step of receiving a message transmitted from one terminal apparatus included in the plurality of terminal apparatuses, in which a user has been identified; and
a notifying step of, in a case where the message received in the receiving step includes information indicating a request to notify the user and a reply message from another terminal apparatus other than the one terminal apparatus included in the plurality of terminal apparatuses has not yet been sent, notifying on the another terminal apparatus the user that the reply message has not yet been sent.

12. A non-transitory computer-readable storage medium storing a program for causing a computer to execute a control method for controlling an information processing apparatus that is communicably connected to a plurality of terminal apparatuses and processes messages exchanged among the plurality of terminal apparatuses,
the control method comprising:
a receiving step of receiving a message transmitted from one terminal apparatus included in the plurality of terminal apparatuses, in which a user has been identified; and
a notifying step of, in a case where the message received in the receiving step includes information indicating a request to notify the user and a reply message from another terminal apparatus other than the one terminal apparatus included in the plurality of terminal apparatuses has not yet been sent, notifying on the another terminal apparatus the user that the reply message has not yet been sent.
